(19) United States
(12) Patent Application Publication
(10) Pub. No.: US 2020/0300408 A1
(43) Pub. Date: Sep. 24, 2020

(54) Mount For an Input Device

(71) Applicant: EDWIN E. MEDINA, DORAL, FL (US)

(72) Inventor: EDWIN E. MEDINA, DORAL, FL (US)

(21) Appl. No.: 16/358,226

(22) Filed: Mar. 19, 2019

(51) Int. Cl. F16M 11/12; B60K 35/00

(52) U.S. Cl. CPC F16M 11/121; B60K 35/00

(57) ABSTRACT

A mount for an input device that is capable of moving or being adjusted in up to nine different axes or directions, but is still stable and sturdy enough to support the necessary weight while the input device is being operated. The mount is made of a number of sleeves, shafts and pivot joints that allow the position of the input device to be moved relative to the vehicle and/or user in up to nine different directions making the mount accessible for almost any disabled driver. Shafts and sleeves are joined together such that the length of a shaft can essentially be shortened by inserting part or the entire shaft into a sleeve. In addition, the sleeves are positioned such that parts of the mount can rotate around the other parts of the mount. Moreover, one or more pivot joints allows for additional mobility.

### BACKGROUND OF THE INVENTION

### (a) Field of the Invention

This disclosure relates to a mount for input devices such as those used in vehicles by disabled drivers; however, the device described herein need not be used exclusively in vehicles or with input devices, but can be used anywhere an item needs to be mounted such that repositioning is desirable.

### (b) Background Art

According to the U.S. Bureau of Transportation Statistics, there are more than 3.5 million people in the United States who never leave their homes. Of those, about 1.9 million of those people are disabled and about 528,000 disabled Americans never leave their homes at least in part due to transportation difficulties. Consequently, the ability to drive drastically improves the lives of many disabled Americans.

Over the years, a number of steering systems that have been designed for disabled people including everything from hand held sticks that can be used to control pedals to electronic joysticks. These latter options combine electronics with mechanics and allow the vehicle's operator to be completely controlled with one or more joysticks. The advantages of these devices are rather obvious; especially when you consider the population at issue has limited mobility—not necessarily just in their lower extremities. The joy stick solution allows disabled people with very limited mobility to independently operate a motor vehicle using their hands. Much like some wheelchairs, a disabled person with severely limited mobility can still operate a motor vehicle with one or more of these devices. However, the presence of this device in a vehicle presents other challenges that need to be addressed.

More specifically, the joystick, or other input device, needs to be mounted somewhere in the vehicle such that the disabled driver can easily access it and such that it stays in position while the vehicle is moving and/or the input device is being operated. Naturally, there are a variety of mounts that can be used to serve this purpose. However, typically, these mounts suffer from a couple of predictable problems. Namely, they tend to be (1) hard to reposition, (2) flimsy and poorly supported and/or (3) bulky and intrusive, such that the disabled driver has difficulty using the input device. Typically, making the mount with enough moving parts that it can easily be repositioned with respect to the driver makes the mount less stable. The mount needs to be able to do more than just support the input device stably while the vehicle is in motion. It also needs to support some of the disabled driver's weight as some drivers will need to rest a portion of the weight of their hand and/or arm on the mount and/or input device when using the same. Of course making the mount more stable by removing moving parts makes the mount hard to position relative to the driver, a key feature needed by those with limited mobility. As a result, the inventor has devised a novel input device mount that solves these difficulties.

### BRIEF SUMMARY OF THE INVENTION

The present invention is a novel mount for an input device that is capable of moving or being adjusted in several different axes or directions, but is still stable and sturdy enough to support the necessary weight placed on it when an input device is being operated. More specifically, the mount is made of a number of sleeves, shafts and pivot joints that allow the position of the input device to be moved relative to the vehicle and/or user in several different directions making the mount accessible for almost any disabled driver.

The device uses a combination of sleeves and shafts to customize the position of the input device. In particular, shafts and sleeves are joined together such that the length of a shaft, or relative distance between opposite ends of the shaft, can be shortened by inserting part of or the entire shaft into a sleeve. In addition, the sleeves are positioned to permit components on the mount to rotate around the longitudinal axis of the sleeves and other components of the mount. Moreover, one or more pivot joints allows for positioning of components at various angles to other components.

More specifically, in preferred embodiments, there is a first sleeve that is fixed to the vehicle door or some other stationary surface inside the vehicle. This first sleeve, or “stationary sleeve”, is attached to said surface in a fixed position—in preferred embodiments, the sleeve is attached to a stationary plate that can be removably attached to the stationary surface such as the inside of the vehicle door. In other embodiments, the first sleeve is attached to the inside of the vehicle such that it can rotate around its longitudinal axis. Complementary threading featured by a structure, such as a cavity, on the stationary plate and a surface of the first sleeve can be used to achieve this end. Other preferred embodiments involve the first sleeve being inserted into an opening in the stationary surface, such as the door. This first sleeve is positioned such that it protrudes from the stationary surface in a plane that is perpendicular or substantially perpendicular to the plate itself allowing the sleeve to extend away from the stationary surface. Substantially perpendicular means that it is within 10 degrees of 90.0 degrees.

In preferred embodiments and the anticipated best mode of the invention, a first shaft is connected to the stationary sleeve such that the shaft and/or the sleeve can rotate about a longitudinal axis, i.e. the first shaft is attached to the sleeve such that the first shaft and the rest of the mount attached to the first shaft, can rotate around the first shaft's longitudinal axis allowing the user to reposition the input device. In the anticipated best mode of this device, the first shaft is connected to the sleeve by inserting a bolt through the longitudinal axis of the shaft such that it engages a wedge-shaped structure inside of the sleeve. The wedge-shaped structure is then inserted into the first sleeve. Tightening the bolt draws the wedge shaped structure towards the head of the bolt, i.e. towards the first shaft and away from the first sleeve. As the bolt is turned, the wedge-shaped structure moves out of alignment with the first shaft while both are inside the first sleeve. This misalignment causes the structure produced by the combined wedge-shaped structure and the first shaft to become stuck, i.e. securely retained, inside the first sleeve.

Regardless of how the first sleeve and first shaft are connected, they are positioned such that the first shaft can move towards and away from the first sleeve and thus the portion of the inside of the vehicle to which the device is attached. Those structures thereby allow the user to increase or decrease the amount of space between the mount and the stationary surface by moving the first shaft towards or away from the first sleeve. As discussed above, the first sleeve is sized and shaped to accommodate or accept the first shaft in its interior. The user need only position the first shaft inside the stationary sleeve, then tighten the bolt running through the first sleeve to lock it in place.

In preferred embodiments and the anticipated best mode of the device, the first shaft is not linear, but rather it has two arms protruding in directions that are substantially perpendicular to each other, i.e. it is L-shaped. In preferred embodiments, and the anticipated best mode of the mount, the two arms of the shaft are welded together to eliminate any movement between the two arms. In other embodiments, the same structure can be formed from two different shafts joined together—a first shaft and a second shaft. For simplicity's sake, the second arm of the first shaft will be henceforth referred to as a second shaft. Just as the first shaft can be moved closer to or away from the stationary surface by engaging with the first sleeve, the second shaft, and the rest of the mount, can be lengthened or shortened. More specifically, the second shaft is connected to a second sleeve such that the second sleeve can be moved over a portion or all of the second shaft, thereby decreasing the length of the mount. In addition, the second sleeve is capable of rotating around its longitudinal axis to create motion in yet another direction. The second sleeve can be attached to the second shaft using any conventional fasteners including nuts and bolts, screws and any other fastener, but in preferred embodiments, the second sleeve is a compression sleeve that fits over the second shaft and is tightened such that the second sleeve squeezes the exterior of the second shaft.

Again in preferred embodiments and the inventor's anticipated best mode, the second sleeve is joined to a third shaft. In preferred embodiments and the anticipated best mode, the second sleeve is attached to the third shaft using a pivoting ear joint fastened with a conventional fastener like a nut and bolt. This configuration allows the third shaft to move up and down relative to the second sleeve, i.e. the third shaft can move in a plane that is substantially perpendicular to the longitudinal axis of the second sleeve.

Finally, a platform is mounted to the third shaft via a third sleeve. The third sleeve wraps around the exterior of the third shaft such that it can pivot or rotate around the longitudinal axis of the third shaft. In addition, the position of the platform relative to the rest of the device can be adjusted by sliding the sleeve to which it is attached along the length of the third shaft. Moreover, the platform can be tipped up and down such that one side of the platform is closer to the rest of the mount than the other side of the platform, i.e. an edge of the platform can be moved toward or away from the longitudinal axis of the shaft to which it is connected. In preferred embodiments and the anticipated best mode of this device, the platform features a pivoting ear joint, i.e. a flattened structure protruding from its underside. Said ear joint features a hole through which a fastener such as a bolt or screw can be placed. This flattened structure is attached to the third sleeve by inserting a fastener through the hole in the flattened device as well as holes in the sleeve.

As a result of the above structures, the inventor has created a novel mount for an input device that is capable of moving or being adjusted in up to nine different axes.

### BRIEF DESCRIPTION OF THE SEVERAL VIEWS OF THE DRAWINGS

FIG. 1 is an exploded view of a preferred embodiment of the present invention;

FIG. 2A is a side plan view of the clamping or second sleeve of the present invention;

FIG. 2B is a bottom plan view of the clamping or second sleeve of the present invention; and

FIG. 3 is a cross sectional view of the first shaft inserted into the first sleeve.

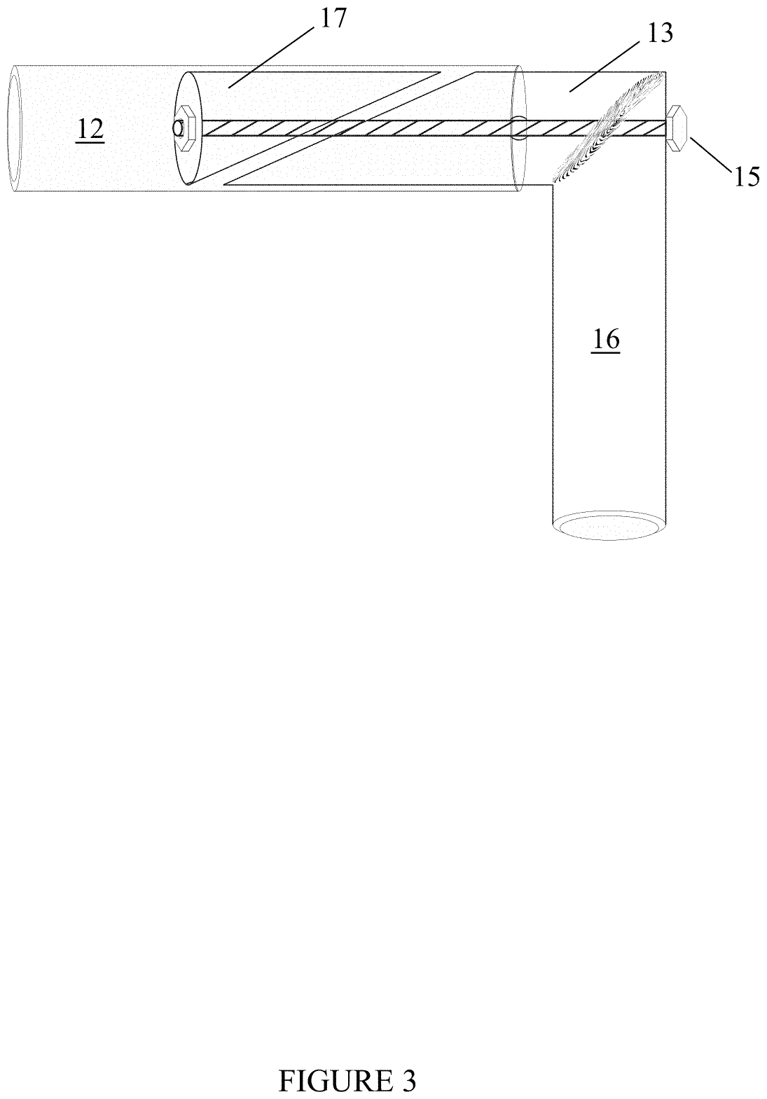

### DETAILED DESCRIPTION OF THE INVENTION

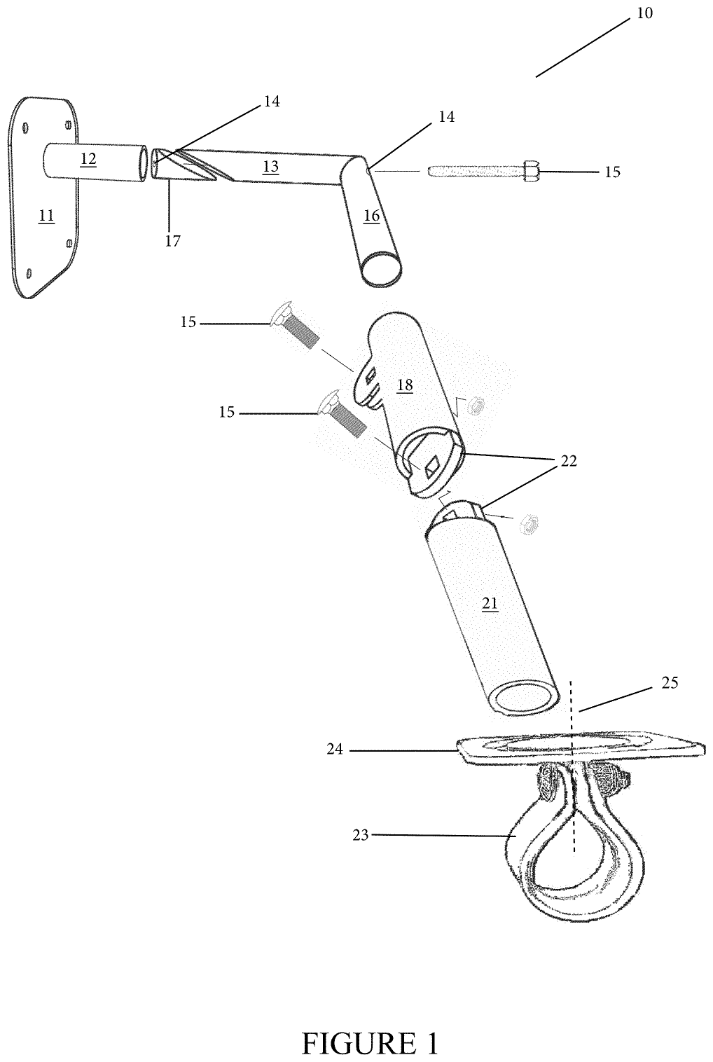

Referring now to the invention in more detail, FIG. 1 shows an exploded view of a preferred embodiment and the best mode of the device. There is a mounting bracket 11 that is fixed to a stationary surface (not shown) inside the vehicle. A skilled artisan could appreciate that the mounting bracket 11 could be attached to other surfaces in the vehicle. In addition, the device need not be used in a vehicle and can be used in other contexts including in the home or office. Specifically, in this embodiment, the mounting bracket 11 is attached to the inside of the vehicle's driver side door. This is an optimal place for a mount for an input device that would be operated by a driver that is seated in a wheelchair. The mounting bracket 11 in this embodiment features a first sleeve 12 protruding from its surface. The angle from which the first sleeve 12 protrudes from the mounting bracket 11 can be any desired angle, but in preferred embodiments, the angle is substantially perpendicular to the mounting bracket 11. Substantially perpendicular means that it is within 10 degrees of 90 degrees.

FIG. 1 also shows the first shaft 13. The first shaft 13 is sized and shaped such that it can be inserted into the first sleeve 12. Since the rest of the device is mounted to the first shaft 13, moving the first shaft 13 into and out of the first sleeve 12 brings the rest of the mount 10 closer or farther away from the stationary surface and thus, the driver of the vehicle (also not shown). In some embodiments, the first shaft 13 has a threaded bore 14 running through its body along its longitudinal axis. The threaded bore 14 accommodates and engages a bolt 15 that is inserted through the bore 14. However, in preferred embodiments, the first and second shaft 13, 16 are hollow tubes and the first shaft 13 has a hole to accommodate a conventional fastener, such as a bolt 15.

In some embodiments of the mount 10, the bolt 15 screws into a bore 14 located in either the first sleeve 12 or in the mounting bracket 11 thereby allowing the user to move the first shaft 13 into and out of the first sleeve 12 by turning the bolt and screwing it further into the mounting bracket 11 or first sleeve 12. FIG. 4 shows how other embodiments of the mount 10 fix the first shaft 13 into the first sleeve 12. In these embodiments and the anticipated best mode of the device, the bolt 15 engages a wedge-shaped structure 17 featuring a bore 14, which is threaded in preferred embodiments. Said wedge-shaped structure 17 is inserted into the first sleeve 12. Tightening the bolt 15 draws the wedge-shaped structure 17 towards the head of the bolt 15, i.e. towards the first shaft 13 and away from the first sleeve 12. As the bolt 15 is turned, the wedge-shaped structure 17 moves out of alignment with the first shaft 13 while both are inserted into the first sleeve 12. This misalignment causes the structure produced by the combined wedge-shaped structure 17 and the first shaft 13 to become stuck or retained inside the first sleeve 12 thereby retaining the first shaft 13 within the first sleeve 12.

Referring back to FIG. 1, this configuration allows the user to rotate the entire mount 10 in a second direction or axis, by rotating the mount around the longitudinal axis of the first shaft 13 and/or the longitudinal axis of the first sleeve 12.

In preferred embodiments and the anticipated best mode of the device, the second shaft 16 is generally positioned at an angle to the first shaft 13. More specifically, the second shaft 16 is connected to the first shaft 13 such that the second shaft 16 is substantially perpendicular to the first shaft 13. However, as can be appreciated by a skilled artisan, this angle can vary significantly to alter the position of the mount 10 and input device (not shown). This second shaft 16 is sized, shaped and positioned, i.e. configured, to fit into the interior of a second sleeve 18 located adjacent to the second shaft 16. In preferred embodiments of the mount 10, this second sleeve 18 is a clamping sleeve that is fitted over the outer surface of the second shaft 16 and tightened over the second shaft 16 by inserting a bolt, screw or other fastener through the clamping ears 20 on the second sleeve 18. A bolt 15 inserted into the clamping ear 20 constricts the area inside the second sleeve 18 as the bolt 15 is tightened and essentially squeezes the second sleeve 18 around the second shaft 16 enough to hold the two pieces together and prevent sliding of the second shaft 16 into or out of the second sleeve 18. By loosening the bolt 15 that squeezes the two clamping ears 20 of the second sleeve 18 together, the second sleeve 18 can be moved along the longitudinal length of the second shaft 16 to create movement in a third direction or axis and thereby shorten or reposition the input device (not shown). This configuration is more stable than joining the pieces end to end because there are fewer joints between parts that can produce unwanted movement.

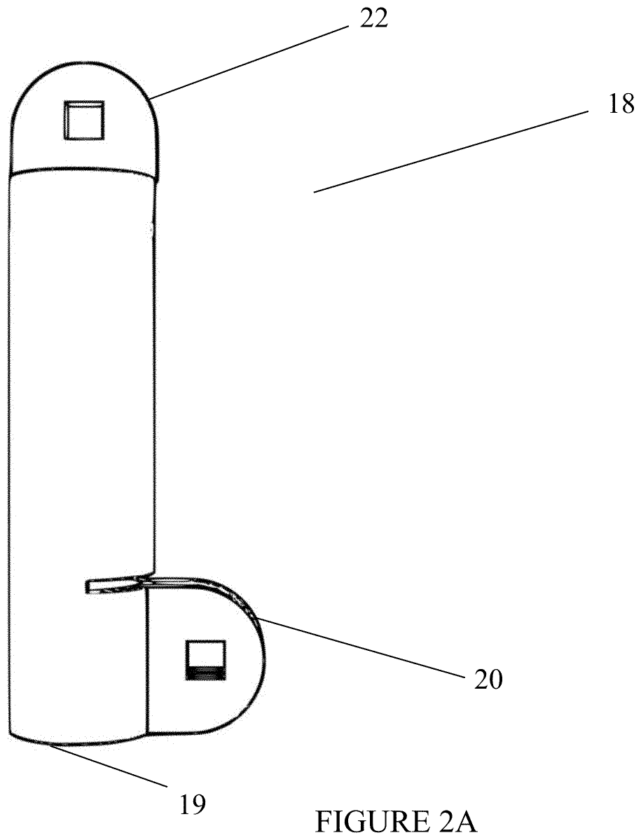

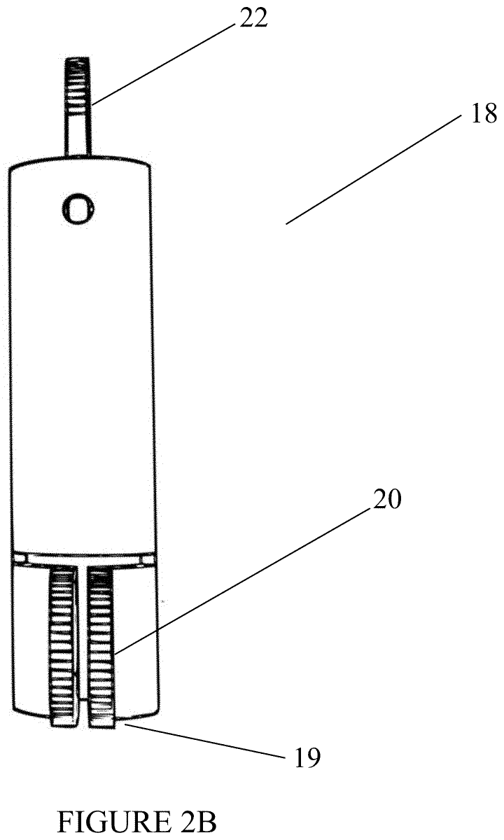

The clamping sleeve is shown in more detail in FIG. 2. FIG. 2 shows that the second sleeve 18 has an open end 19 which allows the second sleeve 18 to accommodate all or a portion of the second shaft 16 as the second sleeve 18 is moved over the second shaft 16. In addition, the other end of the second sleeve 18 features a pivoting ear joint 22 allows the second sleeve 18 to attach to a third shaft 21 (see FIG. 1) also featuring a pivoting ear joint 22. While preferred embodiments use the pivoting ear joints 22 to connect the second sleeve 18 and the third shaft 21, any conventional means of attaching the two pieces could be used.

In addition, the second sleeve 18 can be rotated about its longitudinal axis to further reposition the rest of the mount 10 and the input device thereby creating a fourth axis or direction of movement or adjustment for the mount 10. Ideally, the same size bolt 15 is used throughout the mount 10 thereby decreasing the number of tools required to adjust the position of the mount 10.

As mentioned above and shown in FIG. 1, a third shaft 21 is connected by a pivoting ear joint 22 to the second sleeve 18 at one end. In preferred embodiments, the third shaft 21 is actually an extension sleeve, i.e. a shaft with a hollow interior. A skilled artisan would readily appreciate that the third shaft 21 could be used as another sleeve if the user desired to elongate the mount 10 even further. The pivoting ear joint 22 allows the third shaft 21 to move in a plane that is substantially perpendicular to the longitudinal axis of the second sleeve 18 allowing the user to adjust the mount 10 in a fifth direction or axis.

Referring back to FIG. 1, there is a third sleeve 23 attached to platform ## that accommodates or holds an input device that allows the user to operate the vehicle. The third sleeve 23 is connected to and wraps around the exterior of the third shaft 21. The platform ## is attached to the third sleeve 23. The third sleeve 23 can be moved in two different directions, planes or axes. Specifically, the third sleeve 23 can be rotated about the longitudinal axis of the third shaft 21 and it can be moved along the length or longitudinal axis of the third shaft 21 creating movement in a sixth and seventh direction.

In addition, the platform 24 is connected to the third sleeve by another pivoting ear joint that allows the platform 24 to move at an angle to the longitudinal axis 25 passing through the center of the platform allowing the platform to “tip” one side towards the third sleeve 23 such that the opposing side is positioned further away from the same third sleeve 23 and vice versa thereby allowing movement in an eighth axis.

Reference throughout the specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout the specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

It is understood that the above described embodiments are only illustrative of the application of the principles of the present invention. The present invention may be embodied in other specific forms without departing from its spirit or essential characteristics. The described embodiment, including the best mode, is to be considered in all respects only as illustrative and not restrictive. The scope of the invention is, therefore, indicated by the appended claims, if any, in conjunction with the foregoing description.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

I claim:

1. A mount for an input device that comprises means to adjust said mount in up to 8 different axes.

2. The mount of claim 1 wherein the means to adjust said mount comprises:
a first shaft capable of rotating around its longitudinal axis,
a first sleeve,
a second shaft,
a second sleeve being configured to rotate around a longitudinal axis of the second sleeve or second shaft;
a third shaft,
a third sleeve configured to rotate around a longitudinal axis of the third shaft; and
a platform configured to move in a plane that is at an angle to a vertical axis.

3. The mount of claim 2 wherein the first shaft is sized and positioned such that it can be inserted into and removed from the first sleeve.

4. The mount of claim 3 wherein the second shaft is sized and positioned such that it can inserted into and removed from the second sleeve.

5. The mount of claim 4 wherein one of the sleeves is connected to one of the shafts by a pivoting ear joint.

6. The mount of claim 1 wherein one of the sleeves is connected to one of the shafts by a pivoting ear joint.

7. The mount of claim 5 wherein the platform is attached to the third sleeve and the third sleeve is positioned to rotate around the longitudinal axis of the third shaft.

8. The mount of claim 7 wherein the platform is attached to the third sleeve by an ear joint thereby allowing it to tilt in a plane that is at an angle to the vertical axis of such that the platform can tilt in a horizontal plane.

9. The mount of claim 1 wherein the second sleeve is a clamping sleeve.

10. The mount of claim 4 wherein the second sleeve is a clamping sleeve.

11. The mount of claim 5 wherein the second sleeve is a clamping sleeve.

12. The mount of claim 3 further comprising:
a wedge-shaped piece featuring a bore, said bore featuring threads on an inner surface, said threads being complementary to threads on an outer surface of a bolt; and
a bore in the first shaft featuring a hole;
wherein the bolt is inserted into and through the bore featured by the first shaft and the bore featured by the wedge-shaped piece; and
wherein the wedge-shaped piece is drawn toward the first shaft by tightening the bolt thereby causing the wedge shaped piece to incompletely align with the first shaft.

13. The mount of claim 5 further comprising:
a wedge-shaped piece featuring a bore, said bore featuring threads on an inner surface, said threads being complementary to threads on an outer surface of a bolt; and
a bore in the first shaft featuring a hole;
wherein the bolt is inserted into and through the bore featured by the first shaft and the bore featured by the wedge-shaped piece; and
wherein the wedge-shaped piece is drawn toward the first shaft by tightening the bolt thereby causing the wedge shaped piece to incompletely align with the first shaft.

12. The mount of claim 5 wherein the second sleeve is a clamping sleeve.

13. The mount of claim 12 wherein the second sleeve is a clamping sleeve.

14. A mount for an input device capable of being adjusted in several different axes comprising:
a first sleeve attached to a stationary surface at a first end and attached to a first shaft at a second end; wherein the first sleeve is sized to accommodate the first shaft such that the first shaft can be manually moved in and out of the first sleeve; and
wherein the first sleeve can be rotated in a plane that is perpendicular to the longitudinal axis of the first shaft;
a second shaft with a first end and a second end; wherein the first end of the second shaft is connected to the second end of the first shaft and wherein the second end of the second shaft is connected to a first end of a second sleeve; and
wherein said second sleeve can rotate about the longitudinal axis of the second shaft or the second sleeve and
the second sleeve is connected to the third shaft by a pivot joint allowing the third shaft to move in a plane that is perpendicular to the longitudinal axis of the second sleeve; and
a third sleeve attached to the third shaft such that it can rotate around the longitudinal axis of the third shaft;
a platform attached to the third shaft by the third sleeve.

15. The mount of claim 14 wherein the platform is attached to the third sleeve by an ear joint thereby allowing it to tilt in a horizontal plane.

16. The mount of claim 14 wherein the second sleeve is a clamping sleeve.

17. The mount of claim 14 further comprising:
a wedge-shaped piece featuring a bore, said bore featuring threads on an inner surface, said threads being complementary to threads on an outer surface of a bolt; and
a bore in the first shaft featuring a hole;
wherein the bolt is inserted into and through the bore featured by the first shaft and the bore featured by the wedge-shaped piece; and
wherein the wedge-shaped piece is drawn toward the first shaft by tightening the bolt thereby causing the wedge shaped piece to incompletely align with the first shaft.

18. The mount of claim 15 further comprising:
a wedge-shaped piece featuring a bore, said bore featuring threads on an inner surface, said threads being complementary to threads on an outer surface of a bolt; and
a bore in the first shaft featuring a hole;
wherein the bolt is inserted into and through the bore featured by the first shaft and the bore featured by the wedge-shaped piece; and
wherein the wedge-shaped piece is drawn toward the first shaft by tightening the bolt thereby causing the wedge shaped piece to incompletely align with the first shaft.

19. The mount of claim 16 further comprising:
a wedge-shaped piece featuring a bore, said bore featuring threads on an inner surface, said threads being complementary to threads on an outer surface of a bolt; and
a bore in the first shaft featuring a hole;
wherein the bolt is inserted into and through the bore featured by the first shaft and the bore featured by the wedge-shaped piece; and
wherein the wedge-shaped piece is drawn toward the first shaft by tightening the bolt thereby causing the wedge shaped piece to incompletely align with the first shaft.
